(19) United States
(12) Patent Application Publication
(10) Pub. No.: US 2013/0124880 A1
(43) Pub. Date: May 16, 2013

(54) POWER SUPPLY DEVICE FOR CENTRAL PROCESSING UNIT

(71) Applicants: Qi-Yan LUO, Shenzhen City (CN); Peng CHEN, Shenzhen City (CN); Song-Lin TONG, Shenzhen City (CN)

(72) Inventors: Qi-Yan LUO, Shenzhen City (CN); Peng CHEN, Shenzhen City (CN); Song-Lin TONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,238

(22) Filed: Aug. 31, 2012

(30) Foreign Application Priority Data
Nov. 11, 2011 (CN) 201110356863.9

(51) Int. Cl. G06F 1/26

(52) U.S. Cl. 713/300

(57) ABSTRACT

A power supply device is configured for supplying electrical power to a central processing unit (CPU) of an electronic device. The CPU operates in a number of working modes. The power supply device includes a power supply module operating in a number of power supply modules corresponding to the working modes of the CPU, a number of compensation circuits respectively corresponding to the power supply modes, and a control module. The control module determines the working mode of the CPU and controls the corresponding compensation circuit to electrically connect to the power supply module to provide a loop compensation to the power supply module which improves stability and responding speed of the power supply module.

### BACKGROUND

1. Technical Field

The disclosure generally relates to power supply devices, and particularly to a power supply device for a central processing unit (CPU) in an electronic device, such as a computer.

2. Description of Related Art

A power supply device commonly includes four or more power supply units connected in parallel together to provide large electrical current for a CPU of a computer. When the CPU is in a normal working mode, all of the power supply units supply the electrical power to the CPU together. When the CPU is in a standby mode or sleep mode, only some of the power supply units supply the electrical power to the CPU and the remaining power supply units stop the supplying electrical power to the CPU to improve power supply efficiency.

The power supply device commonly includes only one compensating loop circuit configured for increasing stability and a responding speed of the power supply device especially to the normal working mode. However, when the CPU is in the standby mode or sleep mode, which means only some of the power supply units is used to supply electrical power to the CPU, the compensating loop circuit may not achieve a high enough compensating precision, which may influence the stability and the responding speed of the power supply device.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a power supply device used to supply electrical power to a CPU, according to an exemplary embodiment of the disclosure.

FIG. 2 is a circuit diagram of the power supply device shown in FIG. 1, according to an exemplary embodiment of the disclosure.

### DETAILED DESCRIPTION

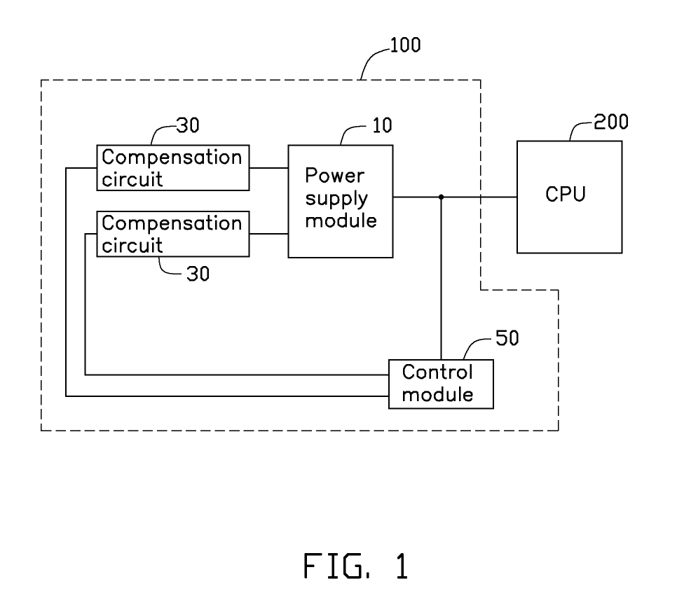

FIG. 1 is a block diagram of a power supply device 100 used to supply electrical power to a CPU 200, according to an exemplary embodiment of the disclosure. The power supply device 100 includes a power supply module 10, a plurality of compensation circuits 30 and a control module 50 electrically connected in series. The CPU 200 operates in a plurality of working modes, such as a normal working mode, a standby mode and a sleep mode. The power supply module 10 operates in a plurality of power supply modes corresponding to the working modes of the CPU 200. Each compensation circuit 30 respectively responds to one of the power supply modes of the power supply mode 10. The control module 50 controls each compensation circuit 30 to provide a loop compensation for the power supply module 10 corresponding to the power supply mode. The power supply module 10 which receives the loop compensation from the compensation circuit 30 can have an improved stability and responding speed. In this embodiment, the power supply device 100 includes two compensation circuits 30 as one example.

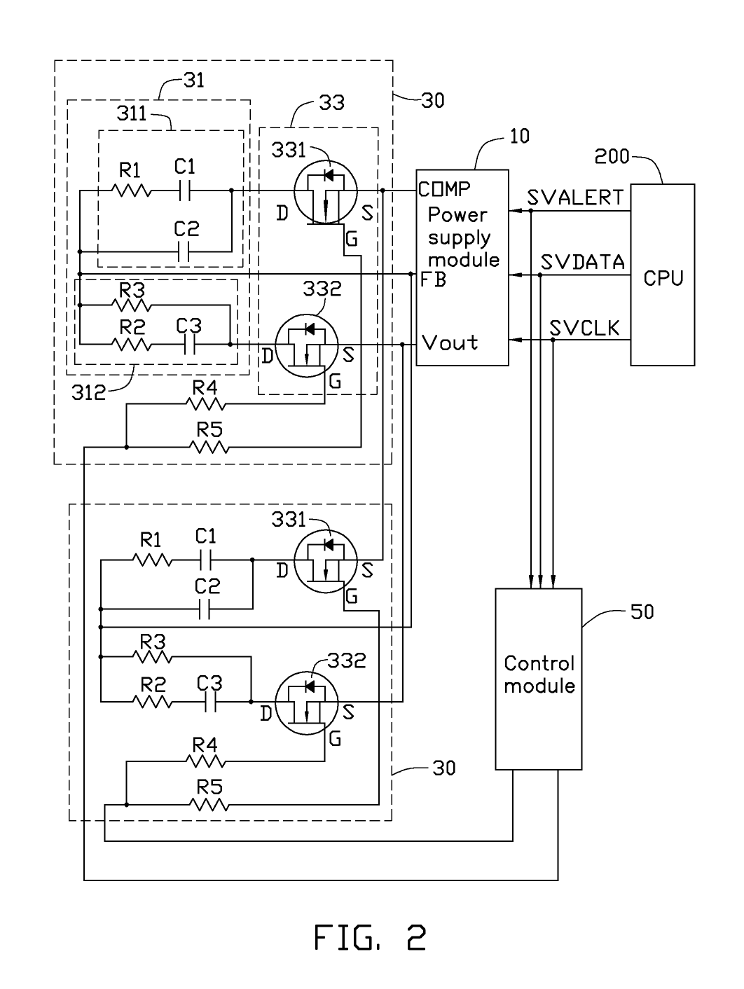

Referring to FIG. 2, the power supply module 10 is electrically connected to the CPU 200 to supply the electrical power to the CPU 200. In one embodiment, the power supply module 10 is electrically connected to the CPU 200 via three signal lines SVCLK, SVDATA, and SVALERT of a power management (PM) bus. The power supply module 10 determines the working mode of the CPU 200 according to signals such as clock signals, data signals or alert signals transmitted from the CPU 200 to the power supply module 10 and selects the corresponding power supply mode for the CPU 200.

The power supply module 10 further includes an output contact Vout, a feedback contact FB, a compensating contact COMP and electrically connected to the compensation circuits 30. The output contact Vout is configured for obtaining a voltage output from the power supply module 10 to CPU 200. The feedback contact FB is configured for sampling the output voltage and feedback the sampled voltage to the power supply module 10. The compensating contact COMP is configured for receiving compensation signals output from the compensation circuits 30 to the power supply module 10 to maintain the output voltage stable and respond fast.

Each compensation circuit 30 has a substantially similar structure which includes a compensating circuit module 31 and a switch module 33. The compensating circuit module 31 is electrically connected to the power supply module 10 via the switch module 33. Difference between the compensation circuits 30 is that parameters, such as resistances of resistors or capacitances of capacitors of each compensation circuits 30, are different.

The compensating circuit module 31 includes a first circuit 311 and a second circuit 312 connected in series.

In this embodiment, the first circuit 311 includes a first resistor R1, a first capacitor C1, and a second capacitor C2. The first resistor R1 and the first capacitor C1 are electrically connected in series. The second capacitor C2 is connected to two ends of the first resistor R1 and the first capacitor C1 in parallel.

The second circuit 312 includes a second resistor R2, a third capacitor C3, and a third resistor R3. The second resistor R2 and the third capacitor C3 are electrically connected in series. The third resistor R3 is electrically connected to two ends of the second resistor R2 and the third capacitor C3 in parallel, and electrically connected to the first circuit 311 in series. A node between the first circuit 311 and a second circuit 312 is electrically connected to the feedback contact FB to feedback the sampled voltage to the power supply module 10.

The switch module 33 includes a first switch 331 and a second switch 332 respectively corresponding to the first circuit 311 and the second circuit 312. In this embodiment, the first switch 331 and the second switch 332 are both metal-oxide-semiconductor field-effect transistors (MOSFETs). A source S of the first switch 331 is electrically connected to the compensating contact COMP. A drain D of the first switch 331 is electrically connected to the first circuit 311. A gate G of the first switch 331 is electrically connected to the control module 50 via a fourth resistor R4.

A source S of the second switch 332 is electrically connected to the output contact Vout. A drain D of the second switch 332 is electrically connected to the second circuit 312. A gate G of the second switch 332 is electrically connected to the control module 50 via a fifth resistor R5.

When the first switch 331 and the second switch 332 is turned on, the corresponding compensating circuit module 31 is electrically connected to the power supply module 10 to input the compensation signal to the power supply module 10. When the first switch 331 and the second switch 332 is turned off, the corresponding compensating circuit module 31 is disconnected from the power supply module 10.

An input end of the control module 50 is electrically connected to the data buses. An output end of control module 50 is electrically connected to the first switch 331 and the second switch 332. The control module 50 determines the working mode of the CPU 200 according to the signals transmitted between the power supply module 10 and the CPU 200, and controls one of the switch modules 33 to turn on thereby selecting one of the compensation circuits 30 corresponding to the working mode of the CPU 200 to connect to the power supply module 10. In this embodiment, the control module 50 may be an integrated baseboard management controller (IBMC), or a complex programmable logic device (CPLD)

When the power supply device 100 supplies the electrical power to the CPU 200, the power supply module 10 selects the corresponding power supply mode for the CPU 200 according to the working mode of the CPU 200. The control module 50 determines the working mode of the CPU 200 and controls the first switch 331 and the second switch 332 of the corresponding compensation circuit 30 to turn on. The corresponding compensation circuit 30 is electrically connected to the power supply module 10 and provides the compensation signal to the power supply module 10.

Therefore, the power supply device 100 can have proper loop compensation in different working modes which improves stability of the power supply and improves responding speed.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power supply device configured for supplying electrical power to a central processing unit (CPU) of an electronic device, the CPU operating in a plurality of working modes, the power supply device comprising:
a power supply module operating in a plurality of power supply modes corresponding to the working modes of the CPU;
a plurality of compensation circuits respectively corresponding to the power supply modes; and
a control module determining the working mode of the CPU and controlling the corresponding compensation circuit to electrically connect to the power supply module to provide a loop compensation to the power supply module which improves stability and responding speed of the power supply module.

2. The power supply device of claim 1, wherein each compensation circuit comprises a compensating circuit module and a switch module, the compensating circuit module is electrically connected to the power supply module via the switch module, the switch module is electrically connected to the control module, the control module controls the switch module to select the corresponding compensating circuit.

3. The power supply device of claim 2, wherein the compensating circuit module comprises a first circuit and a second circuit connected in series, the switch module comprises a first switch and a second switch respectively corresponding to the first circuit and the second circuit, the first circuit and the second circuit are respectively connected to the power supply module by the first and second switches.

4. The power supply device of claim 2, wherein the first switch and the second switch are both metal-oxide-semiconductor field-effect transistors (MOSFETs); a source of the first switch is electrically connected to the power supply module, a drain of the first switch is electrically connected to the first circuit, a gate of the first switch is electrically connected to the control module; a source of the second switch is electrically connected to the power supply module, a drain of the second switch is electrically connected to the second circuit, a gate of the second switch is electrically connected to the control module.

5. The power supply device of claim 4, wherein the power supply module comprises an output contact connected to the source of the second switch, a feedback contact connected to a node between the first circuit and the second circuit, a compensating contact connected to the source of the first switch.

6. The power supply device of claim 4, wherein the first circuit comprises a first resistor, a first capacitor, and a second capacitor; the first resistor and the first capacitor are connected in series; the second capacitor is connected to two ends of the first resistor and the first capacitor in parallel.

7. The power supply device of claim 4, wherein the second circuit comprises a second resistor, a third capacitor, and a third resistor; the second resistor and the third capacitor are connected in series; the third resistor is connected to two ends of the second resistor and the third capacitor in parallel, and then connected to the first circuit in series.

8. The power supply device of claim 4, wherein the power supply module is electrically connected to the CPU via signal lines of a power management bus.
